(19) United States
(12) Patent Application Publication
(10) Pub. No.: US 2012/0260440 A1
(43) Pub. Date: Oct. 18, 2012

(54) DEVICE WITH OBLIQUE AND ECCENTRIC AXLE AND A CLEANING BRUSH

(75) Inventors: Ruiyu HE, (US); Weilin Hu, (US)

(73) Assignee: TRULY INSTRUMENT LIMITED, Shanwei City (CN)

(21) Appl. No.: 13/423,432

(22) Filed: Mar. 19, 2012

(30) Foreign Application Priority Data
Mar. 17, 2011 (CN) 201120070380.8

(51) Int. Cl. F16C 3/22; B24D 11/00; A46B 13/02

(52) U.S. Cl. 15/4; 74/595; 15/184; 15/21.1

(57) ABSTRACT

The utility model relates to a technical field of eccentric structure, which is about an eccentric component and a cleaning brush. The eccentric component comprise of: an axle and a cylinder connected coaxially with such axle, a wedge is set eccentrically on a bottom surface of the cylinder. Said wedge has a convex curved cylindrical surface. The utility model can improve the antiwear property of the eccentric component and prolong its service life through the convex cruved cylindrical surface, which applies the force by linear contact onto the driving block on the application end to make it move reciprocatingly.

### CROSS-REFERENCE TO RELATED APPLICATIONS

This application is based upon and claims the benefit of priority of the prior Chinese Patent Application No. 201120070380.8, filed on Mar. 17, 2011, the entire contents of which are incorporated by reference herein.

### DESCRIPTION

1. Field of the Invention

The utility model relates to the technical field of eccentric structure, especially an eccentric component and a cleaning brush.

2. Background of the Invention

In prior art, a existing eccentric component (shown in FIG. 1) usually comprises of an axle 11, a cylinder 12 and an eccentric ball-end 13 that is set eccentrically on the bottom surface of the cylinder 12. The axle 11 makes the eccentric ball-end 13 to perform circular motion through the drive of a motor, so that the driving block on the application end can move reciprocatingly.

As the eccentric ball-end 13 is in the shape of a ball, when it brings the driving block to perform the reciprocating motion, the force is applied on the tangent point, at which the eccentric ball-end 13 is in contact with the driving block. The method of applying force at the tangent point lead to poor antiwear property and the eccentric ball-end 13 is easy to be damaged.

In conclusion, the usual eccentric components have poor antiwear property.

### SUMMARY OF THE INVENTION

The object of the utility model is to provide an eccentric component that solves the problems of poor antiwear property in existing eccentric components. The embodiment of the utility model is realised by an eccentric component comprising: an axle and a cylinder connected coaxially with the axle, a wedge is set eccentrically on the bottom surface of the cylinder. Said wedge has a convex curved cylindrical surface.

As a preferred embodiment, said wedge could be a truncated cone or part of a truncated cone.

As a preferred embodiment, said wedge could be a cylinder or part of a cylinder.

As a preferred embodiment, said wedge could be a cone or part of a cone.

As a preferred embodiment, the wedge and cylinder are formed integrally.

The utility model also provides a cleaning brush comprising a housing, and said eccentric component is equipped inside the housing.

As a preferred embodiment, the housing of the cleaning brush comprises a handle and a brushing head connected to said handle. The axle is placed within the said handle, and the said cylinder and the said wedge are placed within the said brushing head. Inside the said brushing head, there are a fixing axle and a driving block that moves around the fixing axle. The said wedge and the said driving block are movably assembled.

As a preferred embodiment, there is a slot inside the driving block, the top of the wedge is placed within the slot.

As a preferred embodiment, a scouring pad or hook-and-loop fastener is installed on the exterior part of the head.

The benefit of the utility model comparing with the prior art is that: the antiwear property is improved and the service life is extended through the convex cruved cylindrical surface, which applies the force by linear contact onto the driving block on the application end to make it move reciprocatingly.

### DESCRIPTION OF THE FIGURES

FIG. 1 is a schematic view of the existing eccentric component in the prior art;

FIG. 2 is a schematic view of the device with oblique and eccentric axle that can move reciprocatingly provided by the utility model, in which the wedge is a truncated cone;

FIG. 3 is a schematic view of the cleaning brush provided by the utility model;

FIG. 4 is a schematic view of the device with oblique and eccentric axle that can move reciprocatingly provided by the utility model, in which the wedge is a cone.

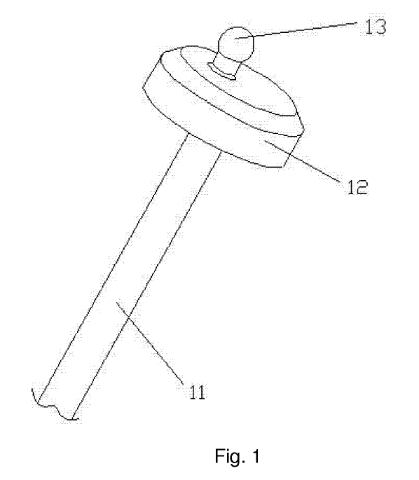

### PREFERRED EMBODIMENT OF THE INVENTION

The utility model will next be described in detail with reference to the figures and embodiments to clarify the object, the technical solution and the advantages of the utility model. It should be noted that the embodiments here are only for describing the utility model, not for limiting the scope of this utility model.

According to this utility model, because convex curved cylindrical surface of the wedge applies the force by linear contact with the driving block on the application end and makes it move reciprocatingly. Therefore the antiwear property of the eccentric component is improved and the service life is extended.

The embodiment of the utility model will be described below:

An eccentric component comprises: an axle and a cylinder connected coaxially with the axle, a wedge is set eccentrically on the bottom surface of the cylinder. Said wedge has a convex curved cylindrical surface.

A cleaning brush comprises a housing, and said eccentric component is equipped inside the housing.

The application of the utility model will be explained in details with reference to the embodiments:

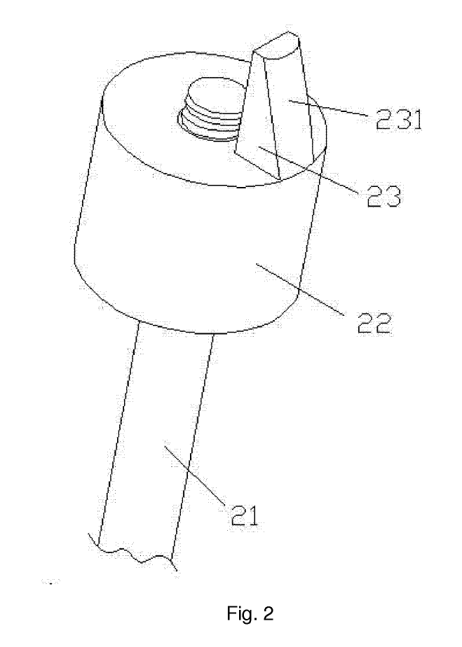

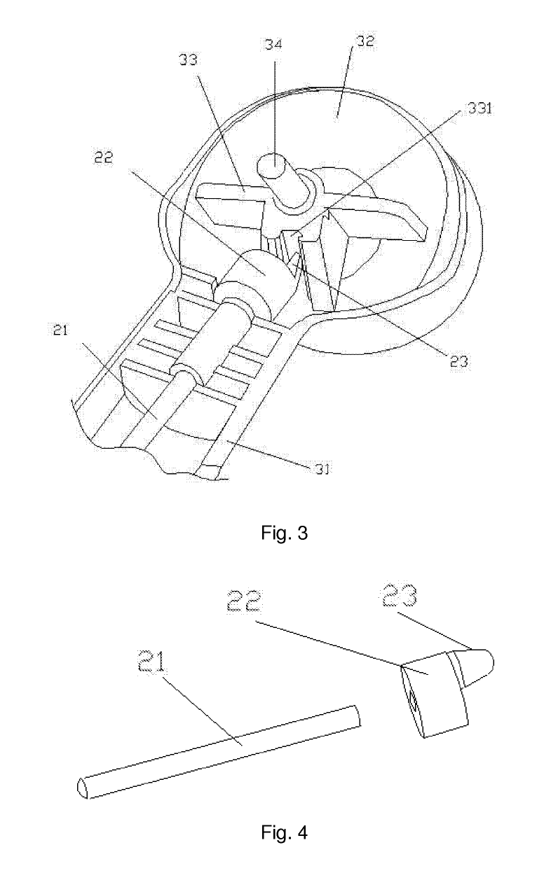

As shown in FIGS. 2 and 3, the utility model provides an eccentric component comprising:

an axle 21 and a cylinder 22 connected coaxially with the axle 21, a wedge 23 is set eccentrically on the bottom surface of the cylinder 22. Said wedge 23 has a convex curved cylindrical surface 231.

In this utility model, the curved surface 231 applies the forces through its linear contact with the driving block 33 on the application end. Comparing with the method of applying force by signal point contact, the antiwear property is greatly improved, while the service life is prolonged.

In the embodiments of the utility model, the wedge 23 could be a truncated cone, part of a truncated cone, a cylinder, part of a cylinder, a cone, or part of a cone. The construction shown in FIG. 2 is an embodiment of the wedge that is part of a truncated cone; and the construction shown in FIG. 4 is an embodiment of the wedge that is part of a cone.

In the embodiments of the utility model, the axle 21 and the cylinder 22 are connected by riveting, while the wedge 23 and cylinder 22 are formed integrally, which makes the installation and the replacement more convenient.

As shown in FIG. 3, the utility model also provides a cleaning brush comprising a housing, and said eccentric component is equipped inside the housing.

The housing of the cleaning brush comprises a handle 31 and a brushing head 32 connected to said handle 31. The axle 21 is placed within the handle 31, the cylinder 22 and the wedge 23 are placed within the brushing head 32. Inside the brushing head 32, there are a fixing axle 34 and a driving block 33 that moves around the fixing axle 34. The wedge 23 and the driving block 33 are movably assembled.

In the embodiments of the utility model, there is a slot 331 inside the driving block 33. The top of the wedge 23 is placed within the slot 331 and can rotate inside the slot 331. When the axle 21 rotates, wedge 23 is caused to perform a circular motion. The circular motion of the wedge 23 ensures the force is applied through linear contact between the surface 231 and the slot 331, so that the driving block 33 can rotate around the fixing axle 34 reciprocatingly. Comparing with the method of applying force by single point contact, the linear contact method improves the antiwear property, while prolong the service life.

In the embodiments of the utility model, a scouring pad or hook-and-loop fastener is installed on the exterior part of the head 32.

The eccentric component and the cleaning brush according to the utility model can improve the antiwear property and prolong the service life through the convex curved cylindrical surface 231 of the wedge 23, which applies the force by linear contact with so that the driving block 33 on the application end is moved reciprocatingly.

The above is only for the description of the preferred embodiments of the utility model, not for limiting the scope of this utility model. Any modifications, equivalent changes and improvements that are within the spirit and principles in the utility model should be included in the scope of protection of the utility model.

What is claimed is:

1. A device with oblique and eccentric axle, comprising: an axle and a cylinder connected coaxially with the axle, wherein a wedge is set eccentrically on the bottom surface of the cylinder, said wedge has a convex curved cylindrical surface.

2. A device with oblique and eccentric axis according to claim 1, wherein said wedge is a truncated cone or part of a truncated cone.

3. A device with oblique and eccentric axle according to claim 1, wherein said wedge is a cylinder or part of a cylinder.

4. A device with oblique and eccentric axle according to claim 1, wherein said wedge is a cone or part of a cone.

5. A device with oblique and eccentric axle according to claim 1, wherein the wedge and cylinder are formed integrally.

6. A cleaning brush comprising a housing, wherein a device with oblique and eccentric axle according to claim 1 is equipped inside the housing.

7. A cleaning brush according to claim 6, wherein the housing of the cleaning brush comprises a handle and a brushing head connected to said handle; the axle is placed within the said handle, and the said cylinder and the said wedge are placed within the said brushing head; inside the said brushing head, there are a fixing axle and a driving block that moves around the fixing axle, the said wedge and the said driving block are movably assembled.

8. A cleaning brush according to claim 7, wherein there is a slot inside the driving block, the top of the wedge is placed within the slot.

9. A cleaning brush according to claim 7, wherein a scouring pad or hook-and-loop fastener is installed on the exterior part of the head.

10. A device with oblique and eccentric axle according to claim 2, wherein the wedge and cylinder are formed integrally.

11. A device with oblique and eccentric axle according to claim 3, wherein the wedge and cylinder are formed integrally.

12. A device with oblique and eccentric axle according to claim 4, wherein the wedge and cylinder are formed integrally.

13. A cleaning brush comprising a housing, wherein a device with oblique and eccentric axle according to claim 2 is equipped inside the housing.

14. A cleaning brush comprising a housing, wherein a device with oblique and eccentric axle according to claim 3 is equipped inside the housing.

15. A cleaning brush comprising a housing, wherein a device with oblique and eccentric axle according to claim 4 is equipped inside the housing.
